(19) United States
(12) Patent Application Publication
(10) Pub. No.: US 2023/0043334 A1
(43) Pub. Date: Feb. 9, 2023

(54) FLIGHT PLAN GENERATION DEVICE AND FLIGHT PLAN GENERATION METHOD

(71) Applicant: KDDI CORPORATION, Tokyo (JP)

(72) Inventors: Takaya TANAKA, Tokyo (JP); Mitsuyoshi MIYAZAWA, Tokyo (JP)

(73) Assignee: KDDI CORPORATION, Tokyo (JP)

(21) Appl. No.: 17/876,363

(22) Filed: Jul. 28, 2022

(30) Foreign Application Priority Data
Aug. 3, 2021 (JP) 2021-127552

(51) Int. Cl. G08G 5/00; G06V 20/17; G06V 10/94; H04N 7/18

(52) U.S. Cl. CPC G08G 5/0034; G06V 10/945; G06V 20/17; H04N 7/183; B64C 39/024

(57) ABSTRACT

A flight plan generation device for generating a flight plan of a flight device that transmits a captured image captured by an imaging unit through wireless communication during flight includes a first acquisition unit configured to acquire target information for specifying an imaging target to be imaged by the imaging unit during flight of the flight device and image quality information for specifying required image quality of a captured image of the imaging target, a second acquisition unit configured to acquire communication quality information on wireless communication quality in a predetermined area including at least a flight airspace of the flight device, and a flight plan generation unit configured to generate a flight plan including a flight path of the flight device and an imaging parameter of the imaging unit based on the acquired target information, image quality information, and communication quality information.

### IN CORPORATION BY REFERENCE

Priority is claimed on Japanese Pat. Application No. 2021-127552, filed Aug. 3, 2021, the content of which is incorporated herein by reference.

### BACKGROUND OF THE INVENTION

### Field of the Invention

The present invention relates to a flight plan generation device and a flight plan generation method.

### Description of Related Art

A technique for flying a flight device including an imaging unit that images an imaging target along a predetermined flight route has been widespread. The flight device can communicate with an external device by using wireless communication and can transmit a captured image captured by the imaging unit to the external device (See, for example, Japanese Unexamined Pat. Application, First Publication No. 2020-201849).

Recently, it has been studied to transmit a captured image captured by an imaging unit in real time through wireless communication during flight of a flight device. However, because communication quality of wireless communication may differ depending on areas, the communication quality may not be sufficiently guaranteed depending on positions of the flight device in flight, and there is a risk that transmission of a captured image may be interrupted or a low-bit-rate image may be transmitted.

### SUMMARY OF THE INVENTION

In view of these points, an object of the present invention is to transmit a captured image obtained by appropriately imaging an imaging target by using an imaging unit of a flight device with desired image quality.

According to a first aspect of the present invention, a flight plan generation device generates a flight plan of a flight device that transmits a captured image captured by an imaging unit through wireless communication during flight. The flight plan generation device includes a first acquisition unit configured to acquire target information for specifying an imaging target to be imaged by the imaging unit during flight of the flight device and image quality information for specifying required image quality of a captured image of the imaging target, a second acquisition unit configured to acquire communication quality information on wireless communication quality in a predetermined area including at least a flight airspace of the flight device, and a flight plan generation unit configured to generate a flight plan including a flight path of the flight device and an imaging parameter of the imaging unit based on the acquired target information, image quality information, and communication quality information.

The flight plan generation unit may image the imaging target specified from the acquired target information and may generate the flight plan including a recommended flight path that transmits the captured image satisfying the required image quality through wireless communication.

Further, when the recommended flight path does not exist, the flight plan generation unit may notify a user of non-existence of the recommended flight path.

Further, the imaging parameter may include an imaging direction of the imaging unit during flight of the flight device and image quality information for specifying image quality of the captured image.

Further, the image quality information may include at least one of resolution, a bit rate, and a frame rate of the captured image.

Further, the imaging parameter may include at least one of an angle of view, brightness, and an image compression rate of the captured image.

Further, the first acquisition unit may acquire the target information including a flight path of the flight device and an imaging direction of the imaging unit input by a user.

Further, the flight plan generation unit may generate the flight plan including a flight path different from the flight path included in the target information.

Further, the first acquisition unit may acquire the image quality information selected by a user according to a model of the imaging unit from a plurality of pieces of information on the required image quality.

Further, the flight plan generation unit may present the generated flight plan to a user and may output the flight plan to a flight control unit that controls the flight of the flight device, on a condition that the presented flight plan is approved by the user.

Further, the second acquisition unit may acquire the communication quality information based on wireless communication quality when the flight device has flown in the past in the predetermined area, or wireless communication quality when another flight device has flown in the past in the predetermined area.

Further, the second acquisition unit may acquire the communication quality information indicating wireless communication quality estimated by a simulator.

Further, the flight plan generation device may further include a storage unit configured to store imaging unit information on an imaging unit installed on a ground in the predetermined area, in which the flight plan generation unit may generate the flight plan based on the imaging unit information stored in the storage unit.

Further, the first acquisition unit may further acquire flight purpose information on a purpose of flight of the flight device, and the flight plan generation unit may control the generation of the flight plan further based on the flight purpose information.

According to a second aspect of the present invention, a flight plan generation method generates a flight plan of a flight device that transmits a captured image captured by an imaging unit through wireless communication during flight. The flight plan generation method includes a step of acquiring target information for specifying an imaging target to be imaged by the imaging unit during flight of the flight device and image quality information for specifying required image quality of a captured image of the imaging target, a step of acquiring communication quality information on wireless communication quality in a predetermined area including at least a flight airspace of the flight device, and a step of generating a flight plan including a flight path of the flight device and an imaging parameter of the imaging unit based on the acquired target information, image quality information, and communication quality information.

According to the present invention, there is an effect that a captured image obtained by appropriately imaging an imaging target by using an imaging unit of a flight device can be transmitted with desired image quality.

### BRIEF DESCRIPTION OF THE DRAWINGS

FIG. 1 is a schematic diagram showing an overview of flight management by a flight management system according to an embodiment.

FIG. 2 is a block diagram showing a configuration of a user terminal in the flight management system.

FIG. 3 is a block diagram showing a configuration of the flight management system.

FIG. 4 is a block diagram showing a configuration of a flight plan generation device in the flight management system.

FIG. 5 is a schematic diagram showing an input flight path input by a user in the flight management system.

FIG. 6 is a schematic diagram showing a recommended flight path in the flight management system.

FIG. 7 is a block diagram showing a configuration of a flight device in the flight management system.

FIG. 8 is a flowchart showing an operation example of the flight management system.

### DETAILED DESCRIPTION OF THE EMBODIMENTS

### Overview of Flight Management of Flight Device

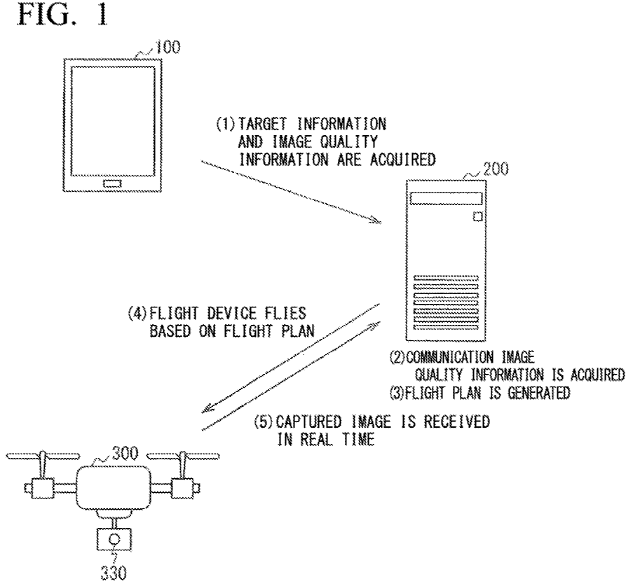

An overview of flight management of a flight device by a flight management system according to an embodiment will be described with reference to FIG. 1.

FIG. 1 is a schematic diagram showing an overview of flight management by the flight management system according to the embodiment. A flight management system 200 manages flight of a flight device 300. The flight management system 200 causes the flight device 300 to fly according to an approved flight plan. The flight management system 200 receives in real time a captured image captured by an imaging unit of the flight device 300 while the flight device 300 is flying according to a flight plan.

A user terminal 100 is used by a user of the flight device 300. The user terminal 100 is, for example, a smartphone, a tablet terminal, or the like. The user terminal includes a display unit for displaying information and an input unit for performing an input operation by a user. The user terminal 100 transmits and receives information to and from the flight management system 200. A user can input a scheduled flight plan related to a flight path or the like of the flight device 300 to the user terminal 100. The user terminal 100 transmits information (for example, a scheduled flight plan) input by a user to the flight management system 200.

The flight device 300 is, for example, an unmanned flight device such as a drone and can be monitored, inspected, aerially imaged, delivered, and the like. An imaging unit 330 that captures a surrounding image is mounted on the flight device 300. The flight device 300 flies a predetermined flight path and performs a predetermined operation. For example, the flight device 300 captures an image of a target as a predetermined operation while flying on a flight path generated by the flight management system 200.

The flight management system 200 of the present embodiment generates a flight plan of the flight device 300 such that the flight device 300 can transmit in real time a captured image of the imaging target with desired image quality captured by the imaging unit 330. Hereinafter, overview of processes performed by the flight management system 200 will be described with reference to FIG. 1.

The flight management system 200 acquires, from the user terminal 100, target information for specifying an imaging target to be imaged by the imaging unit of the flight device 300, and image quality information for specifying required quality of a captured image of the imaging target (a process (1) in FIG. 1).

The flight management system 200 acquires communication quality information on wireless communication quality in a predetermined area including at least a flight airspace of the flight device 300 (a process (2) in FIG. 1). For example, the flight management system 200 acquires communication quality information from a database that stores wireless communication quality for each area. Here, the wireless communication quality is, for example, reference signal received power (RSRP) or signal to interference plus noise power ratio (SINR) that indicates LTE reception quality. RSRP represents a parameter that evaluates a reception level of radio waves. SINR represents a ratio between power of a desired signal and power of a received signal (for example, an interference wave and thermal noise) other than the desired signal.

The flight management system 200 generates a flight plan including a flight path of the flight device 300 and an imaging parameter of the imaging unit 330 based on the target information, the image quality information, and the communication quality information acquired in the above-described processes (1) and (2) (a process (3) in FIG. 1). For example, the flight management system 200 generates an alternative flight plan when a scheduled flight plan input to the user terminal 100 by a user is inappropriate. The flight management system 200 may generate a flight plan including a path passing through an area where a value of the above-described RSRP or SINR is greater than a predetermined threshold value.

The flight management system 200 causes the flight device 300 to fly based on the generated flight plan (a process (4) in FIG. 1). The flight device 300 flies along a flight path in the flight plan and images an imaging target based on an imaging parameter in the flight plan. The flight management system 200 receives a captured image captured during flight from the flight device 300 in real time (a process (5) in FIG. 1). The flight management system 200 may transmit the received captured image to the user terminal 100.

By generating a flight plan based on target information, image quality information, and communication quality information as in the above-described process (3), a flight path of the flight device 300 can be set to a stable path of wireless communication quality, and the imaging unit 330 can image a captured image that satisfies required image quality. As a result, the flight device 300 flying according to the generated flight plan can transmit the captured image of the imaging target with desired image quality captured by the imaging unit 330 to the flight management system 200 in real time.

### Configuration of User Terminal

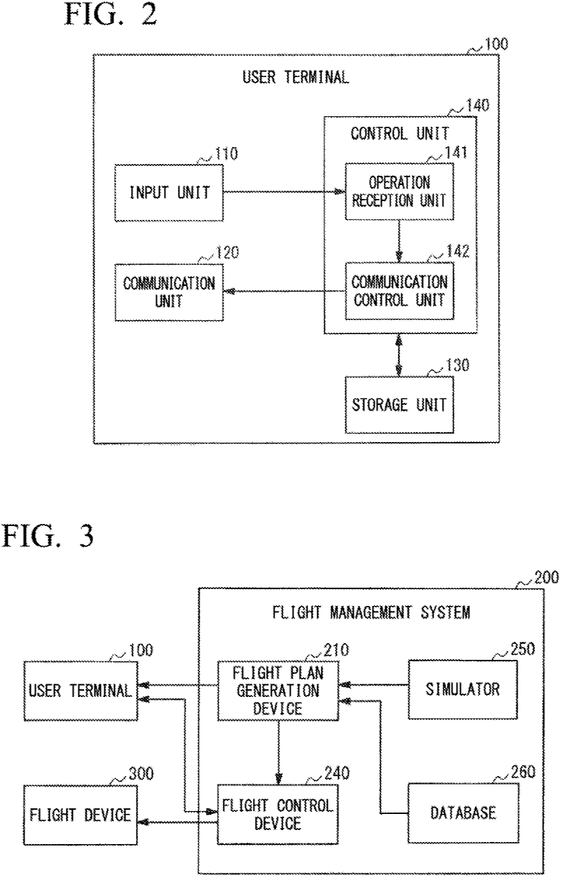

FIG. 2 is a block diagram showing the configuration of the user terminal 100. As shown in FIG. 2, the user terminal 100 includes an input unit 110, a communication unit 120, a storage unit 130, and a control unit 140.

The input unit 110 is a portion where a user performs an input operation. The input unit 110 is, for example, a touch panel for detecting a user’s input operation on a display surface for displaying an image, a character, or the like. The communication unit 120 is a wireless communication module for communicating with the flight management system 200 via a wireless communication network.

The storage unit 130 is a storage medium including a read only memory (ROM), a random access memory (RAM), and the like. The storage unit 130 stores a program executed by the control unit 140. The control unit 140 is, for example, a central processing unit (CPU). The control unit 140 functions as an operation reception unit 141 and a communication control unit 142 by executing a program stored in the storage unit 130.

The operation reception unit 141 receives an operation input by a user to the input unit 110. For example, the operation reception unit 141 receives a scheduled flight path (hereinafter, also referred to as an input flight path) of the flight device 300 which is input by a user. Further, the operation reception unit 141 receives an imaging target, which is input by a user, to be imaged by the imaging unit 330 of the flight device 300, and required image quality of a captured image of the imaging target.

The communication control unit 142 communicates with the flight management system 200 via the communication unit 120. For example, the communication control unit 142 transmits information on an input flight path received by the operation reception unit 141 to the flight management system 200.

### Configuration of Flight Management System

FIG. 3 is a block diagram showing the configuration of the flight management system 200. As shown in FIG. 3, the flight management system 200 includes a flight plan generation device 210, a flight control device 240, a simulator 250, and a database 260.

The flight plan generation device 210 generates a flight plan for the flight device 300. For example, the flight plan generation device 210 generates a flight plan as an alternative plan when a scheduled flight plan input to the user terminal 100 by a user is not appropriate. The flight plan generation device 210 generates a flight plan based on information on an imaging target input to the user terminal 100 by a user and required image quality of a captured image of the imaging target. Further, the flight plan generation device 210 generates a flight plan based on a result of simulation performed by the simulator 250 and information (for example, information on wireless communication quality) stored in the database 260.

The flight plan generation device 210 may receive approval of a user by having the user terminal 100 present the generated flight plan. The flight plan generation device 210 outputs the generated flight plan to the flight control device 240 on the condition of approval of a user. A detailed configuration of the flight plan generation device 210 is described below.

The flight control device 240 controls flight of the flight device 300. The flight control device 240 controls the flight of the flight device 300 according to a flight plan generated by the flight plan generation device 210. For example, the flight control device 240 causes the flight device 300 to fly along a flight path in the flight plan and causes the imaging unit 330 to capture an image based on imaging parameters in the flight plan.

The simulator 250 performs simulation on wireless communication. For example, the simulator 250 performs simulation on wireless communication quality of an area of a flight plan of the flight device 300. Further, the simulator 250 may perform simulation on an angle of view imaged by the imaging unit 330.

The database 260 stores communication quality information on the wireless communication quality for each area in which the flight device 300 flies. Further, the database 260 stores model information on a model of the flight device 300.

### Detailed Configuration of Flight Plan Generation Device 210

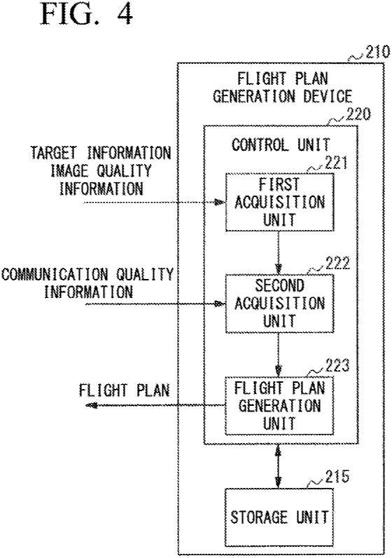

FIG. 4 is a block diagram showing a configuration of the flight plan generation device 210. As shown in FIG. 4, the flight plan generation device 210 includes a storage unit 215 and a control unit 220.

The storage unit 215 is a storage medium including a read only memory (ROM), a random access memory (RAM), and the like. The storage unit 215 stores a program executed by the control unit 220.

The control unit 220 is, for example, a central processing unit (CPU). The control unit 220 functions as a first acquisition unit 221, a second acquisition unit 222, and a flight plan generation unit 223 by executing the program stored in the storage unit 215.

The first acquisition unit 221 acquires target information for specifying an imaging target to be imaged by the imaging unit 330 during flight of the flight device 300 and image quality information for specifying required image quality of a captured image of the imaging target. For example, the first acquisition unit 221 acquires target information and image quality information input to the user terminal 100 by a user from the user terminal 100.

The target information includes an imaging target and the surroundings. The target information includes a flight path of the flight device 300 for imaging the imaging target. Further, the target information includes an imaging direction in which the imaging unit 330 images an imaging target during flight of the flight device 300. Because the flight path and the imaging direction are input to the user terminal 100 by a user here, the first acquisition unit 221 acquires target information including the flight path of the flight device 300 and the imaging direction of the imaging unit 330 which are input by a user. The target information may include position information of the imaging target instead of the flight path. In this case, the flight plan generation unit 223 may obtain a flight path by acquiring position information of an imaging target.

Image quality information may be any information for specifying required image quality and includes, for example, resolution of a captured image. However, the image quality information is not limited thereto and may further include a bit rate or a frame rate of a captured image.

The first acquisition unit 221 may acquire image quality information selected from a plurality of pieces of information on the required image quality by a user according to a model of the imaging unit 330. Because various models of the imaging unit 330 can be mounted on the flight device 300 and performance of the imaging unit 330 may differ depending on the models, image quality of the captured image of the imaging unit 330 also differs depending on the models. Therefore, a user can select image quality information in the user terminal 100 depending on the models of the imaging unit 330. Thereby, it is possible to capture an image with image quality appropriate for the model of the imaging unit 330.

The second acquisition unit 222 acquires communication quality information on wireless communication quality in a predetermined area including at least a flight airspace of the flight device 300. For example, the second acquisition unit 222 specifies a predetermined area from a flight path acquired by the first acquisition unit 221 and acquires communication quality information corresponding to the specified predetermined area.

The second acquisition unit 222 acquires communication quality information, which is stored in the database 260 (FIG. 3), on wireless communication quality when a flight device has flown in the past in a predetermined area. For example, the second acquisition unit 222 acquires the communication quality information based on the wireless communication quality when the flight device 300 has flown in the past in a predetermined area. Alternatively, the second acquisition unit 222 acquires communication quality information based on wireless communication quality when another flight device 300 has flown in the past in a predetermined area. Thereby, communication quality information based on actual wireless communication quality can be acquired, and thus, highly reliable communication quality information can be used.

The wireless communication quality in the predetermined area may be an estimated value rather than a value actually measured previously. For example, the second acquisition unit 222 acquires communication quality information indicating wireless communication quality of a predetermined area estimated by the simulator 250 (FIG. 3). That is, the second acquisition unit 222 acquires communication quality information as a result that the simulator 250 simulated the wireless communication quality in the predetermined area. Thereby, communication quality information can be acquired even in a predetermined area for the first flight.

The flight plan generation unit 223 generates a flight plan of the flight device 300. The flight plan generation unit 223 generates a flight plan based on information acquired by the first acquisition unit 221 and the second acquisition unit 222. Specifically, the flight plan generation unit 223 generates a flight plan including a flight path of the flight device 300 and an imaging parameter of the imaging unit 330 based on the target information and image quality information acquired by the first acquisition unit 221 and the communication quality information acquired by the second acquisition unit 222.

The imaging parameter included in the generated flight plan includes an imaging direction of the imaging unit 330 in flight of the flight device 300 and image quality information for specifying image quality of a captured image. Here, the imaging direction is a direction toward an imaging target during the flight of the flight device 300. For example, the flight plan generation unit 223 sets an imaging direction such that the imaging unit 330 always faces an imaging target when the flight device 300 flies while meandering.

Image quality information included in the imaging parameter may include any of resolution, a bit rate, and a frame rate of a captured image. However, the image quality information is not limited thereto and may include all of the resolution, the bit rate, and the frame rate. As such, the image quality information includes at least one of resolution, a beat rate, and a frame rate of a captured image. Thereby, it is possible to prevent the flight device 300 from transmitting a low-quality captured image.

The imaging parameter may include any of an angle of view, brightness, and an image compression rate of a captured image. However, the imaging parameter is not limited thereto and may include all of the angle of view, brightness, and image compression rate. As such, the imaging parameter included in the flight plan includes at least one of an angle of view, brightness, and an image compression rate of a captured image.

The flight plan generation unit 223 determines whether a scheduled flight path included in the target information acquired by the first acquisition unit 221 is appropriate for wireless communication during flight. For example, the flight plan generation unit 223 determines whether the scheduled flight path is appropriate for wireless communication, based on the scheduled flight path and communication quality information of a predetermined area (an area including the flight path) acquired by the second acquisition unit 222. The communication quality information indicates a communication area where wireless communication is possible, and if a ratio of the scheduled flight path overlapping the communication area is less than a predetermined threshold value, it is determined that the scheduled flight path is not appropriate. If the ratio of the scheduled flight path overlapping the communication area is greater than or equal to the threshold value, the flight plan generation unit 223 determines that the scheduled flight path is appropriate. In this case, the flight plan generation unit 223 adopts a scheduled flight path included in target information as a flight path.

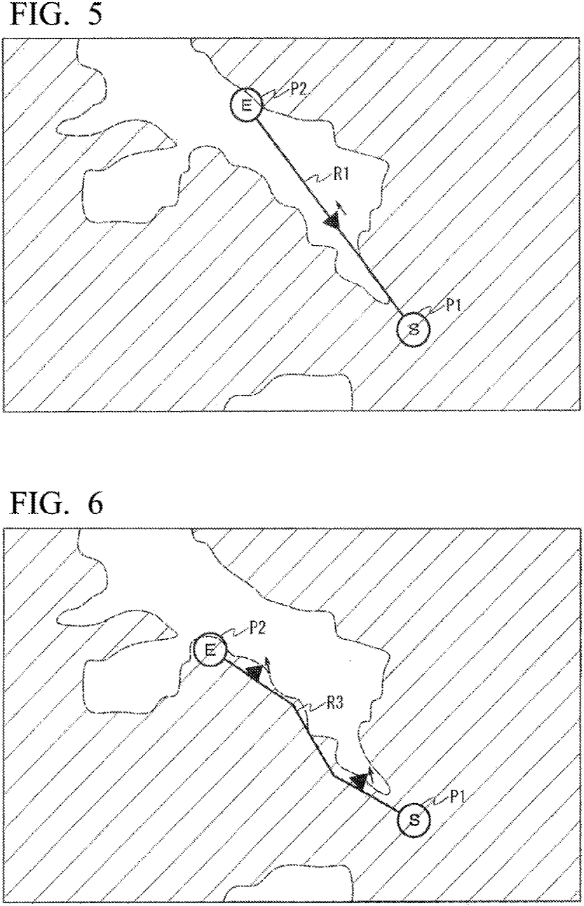

When it is determined that the scheduled flight path (specifically, an input flight path input by a user) included in the target information is not appropriate, the flight plan generation unit 223 generates a recommended flight path different from the input flight path. For example, the flight plan generation unit 223 can image an imaging target specified from the acquired target information and generates a flight plan including a recommended flight path in which a captured image satisfying required image quality can be transmitted through wireless communication. Thereby, communication quality can be sufficiently guaranteed, and transmission of a captured image can be prevented from being interrupted, or a low-bit-rate image can be prevented from being transmitted. Hereinafter, a specific description will be made with reference to FIGS. 5 and 6.

FIG. 5 is a schematic diagram showing an input flight path input by a user. FIG. 5 shows a predetermined area including a flight airspace of the flight device 300. A hatched region is an in-service area where wireless communication of a long term evolution (LTE) type can be made, and a non-hatched region is an out-of-service area where wireless communication cannot be made. It is assumed that a user cannot discriminate between the in-service area and the out-of-service area, and an input flight path R1 shown in FIG. 5 is input. The input flight path R1 is a path obtained by connecting a starting place P1 of the flight device 300 to a destination P2 thereof in a straight line. An imaging direction (a direction indicated by an arrow in FIG. 5) of the imaging unit 330 when flying in the input flight path R1 is the same as a flight direction. As shown in FIG. 5, most of the input flight path R1 is an out-of-service area. Therefore, when the flight device 300 flies along the input flight path R1, it is difficult to transmit a captured image.

The flight plan generation unit 223 generates a recommended flight path through which the flight device 300 flies in an in-service area as a flight path different from the input flight path. For example, the flight plan generation unit 223 generates a recommended flight path shown in FIG. 6.

FIG. 6 is a schematic diagram showing a recommended flight path. A recommended flight path R3 connects the starting place P1 of the flight device 300 to a destination P3 thereof. The destination P3 is a position different from the destination P2 shown in FIG. 5 and is located in the in-service area. Further, the recommended flight path R3 is different from the input flight path R1 shown in FIG. 5 and is a bent path so as to be located in the in-service area as shown in FIG. 6. Further, an imaging direction of the imaging unit 330 when flying on the recommended flight path R3 is a direction of the arrow shown in FIG. 6 and is a direction in which the imaging unit 330 faces an imaging target. Therefore, when flying along the recommended flight path R3, the flight device 300 can transmit in real time a captured image captured by appropriately imaging an imaging target.

When the recommended flight path does not exist, the flight plan generation unit 223 may notify a user of non-existence of the recommended flight path. For example, the flight plan generation unit 223 transmits information on a fact that the recommended flight path does not exist to the user terminal 100, and the user terminal 100 that has received the information displays the fact on a display unit. Thereby, a user can recognize that there is no recommended flight path.

The flight plan generation unit 223 has a function of presenting the generated flight plan to a user. For example, the flight plan generation unit 223 transmits the generated flight plan to the user terminal 100, and the user terminal 100 causes a display unit to display the received flight plan. Thereby, a user can check the generated flight plan, thereby being capable of approving a flight plan or inputting again another flight plan. The flight plan generation unit 223 outputs the generated flight plan to the flight control device 240 that controls flight of the flight device 300 on the condition that a user approved the presented flight plan. Therefore, the flight control device 240 causes the flight device 300 to fly according to the flight plan approved by the user. Thereby, it is possible to prevent the flight device 300 from flying according to a flight plan that a user does not want.

### Modification Example 1

When generating a flight plan, the flight plan generation unit 223 may refer to imaging unit information on an imaging unit (hereinafter, referred to as an installation imaging unit) installed on the ground in a predetermined area. The installation imaging unit is, for example, an imaging unit installed at a position that can be a takeoff point or a landing point of the flight device 300. The installation imaging unit can more appropriately image the takeoff point and the landing point than the imaging unit 330 of the flight device 300.

Imaging unit information is stored in the storage unit 215 herein. For example, the imaging unit information is stored in association with an installation position of the installation imaging unit and a model of the installation imaging unit. At this time, the flight plan generation unit 223 generates a flight plan further based on the imaging unit information stored in the storage unit 215. For example, the flight plan generation unit 223 generates a flight plan in which two installation imaging units are set as a takeoff point and a landing point. In this case, at the time of takeoff and landing of the flight device 300, the installation imaging unit captures an image instead of the imaging unit 330.

### Modification Example 2

In the above description, the flight plan generation unit 223 generates a recommended flight plan different from an input flight plan but may control generation of a flight plan based on a purpose of flight (in other words, a purpose of imaging) of the flight device 300. This will be described in detail below.

The first acquisition unit 221 acquires flight purpose information on a purpose of flight of the flight device 300. The flight purpose information is, for example, information input by a user to the user terminal 100, and the first acquisition unit 221 acquires the flight purpose information from the user terminal 100. The purpose of flight of the flight device 300 includes, for example, monitoring, inspection, aerial imaging, and delivery.

The flight plan generation unit 223 controls generation of a flight plan based on the flight purpose information acquired by the first acquisition unit 221. For example, when a purpose of flight is monitoring or aerial imaging, it is considered that the purpose can be achieved even if a flight path changes slightly, and thus, the flight plan generation unit 223 generates a recommended flight plan to change the flight path and an imaging parameter. When the purpose of flight is delivery, a purpose of imaging is to check that the surroundings are safe for the flight device to fly, and it does not matter where to image, and thus, the flight plan generation unit 223 generates a recommended flight plan in which a flight path changes but an imaging parameter does not change. When the purpose of flight is inspection, whether a desired inspection target can be imaged differs depending on an imaging direction even when a flight path changes, and thus, whether to generate the recommended flight plan according to the imaging direction is determined. For example, in a case where the imaging direction is directly below, when a flight path changes, an inspection target cannot be imaged, and thus, the flight plan generation unit 223 does not generate a recommended flight plan.

During monitoring, it is desirable to check a flight direction and a state of a body of the flight device 300 by using the imaging unit 330 of the flight device 300. Further, a monitoring area to be monitored is imaged at a desired resolution (for example, resolution at which a person can be discriminated). In a case of nighttime monitoring, the monitoring may be performed by a thermal camera or by irradiating a monitoring area with light from LED light.

During inspection, it is desirable to check a flight direction and a state of a body of the flight device 300 by using the imaging unit 330. Further, an inspection target to be inspected is imaged at a desired resolution (for example, resolution at which cracks in a building such as a steel tower can be discriminated) and an angle. At this time, it is desirable to perform imaging from a direction that does not backlight the sun.

Further, during aerial imaging, it is desirable to check a flight direction and a state of a body of the flight device 300 by using the imaging unit 330. Further, a landscape or a structure to be aerially imaged is imaged at a desired resolution (for example, a beautiful resolution when viewed on a television) and an angle. At this time, it is desirable to perform imaging from a direction that does not backlight the sun. During delivery, it is desirable to check a flight direction and a state of a body of the flight device 300 by using the imaging unit 330.

In the above description, monitoring and the like in flight are described, but the following operations are desirable at the time of takeoff and landing of the flight device 300. During monitoring, inspection, aerial imaging, and takeoff of delivery, it is desirable to image an image overlooking the surroundings of a takeoff point and to check that a third party is not in the takeoff point (or is not trying to be in the takeoff point). Further, during monitoring, inspection, aerial imaging, and landing of delivery, it is desirable to image an image overlooking the surroundings of a landing point and to check that there are no obstacles and a third party is not in the landing point (or is not trying to be in the landing point).

### Configuration of Flight Device

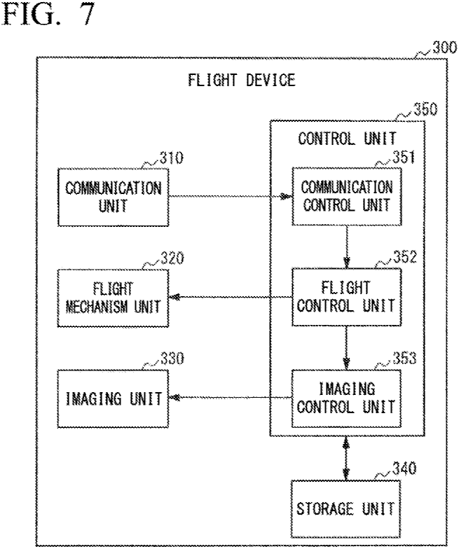

FIG. 7 is a block diagram showing a configuration of the flight device 300. The flight device 300 is, for example, a drone. As shown in FIG. 7, the flight device 300 includes a communication unit 310, a flight mechanism unit 320, an imaging unit 330, a storage unit 340, and a control unit 350. The flight device 300 can transmit a captured image captured by the imaging unit 330 through wireless communication during flight. Here, the flight device 300 transmits the captured image to the flight management system 200 through wireless communication in real time.

The communication unit 310 is a communication module for wireless communication with the flight management system 200. For example, the communication unit 310 performs wireless communication by using a communication standard of LTE.

The flight mechanism unit 320 includes, for example, a plurality of propellers and a motor for rotating the respective propellers. By controlling a rotation speed of the propeller, the flight device 300 can raise, drop, turn, move back and forth, and move left and right.

The imaging unit 330 images the surroundings of the flight device 300. For example, the imaging unit 330 images an imaging target located thereunder during flight of the flight device 300.

The storage unit 340 is a storage medium including a ROM, RAM, and the like. The storage unit 340 stores a program executed by the control unit 350.

The control unit 350 is, for example, a CPU. The control unit 350 functions as a communication control unit 351, a flight control unit 352, and an imaging control unit 353 by executing the program stored in the storage unit 340.

The communication control unit 351 communicates with the flight management system 200 via the communication unit 310. The communication control unit 351 receives a flight plan from the flight management system 200. The communication control unit 351 transmits a captured image captured by the imaging unit 330 during flight of the flight device 300 to the flight management system 200 in real time.

The flight control unit 352 drives the flight mechanism unit 320 to control flight of the flight device 300. The flight control unit 352 causes the flight device 300 to fly along a flight path included in a flight plan received from the flight management system 200.

The imaging control unit 353 controls imaging of the imaging unit 330. The imaging control unit 353 controls the imaging of the imaging unit 330 based on an imaging parameter included in a flight plan received from the flight management system 200. For example, the imaging control unit 353 adjusts a direction of the imaging unit 330 during flight of the flight device 300 based on an imaging direction included in the imaging parameter. Further, the imaging control unit 353 causes the imaging unit 330 to image an image based on resolution, a bit rate, and a frame rate included in an imaging parameter. Thereby, an imaging target can be imaged as a high-quality captured image.

### Operation Example of Flight Management System 200

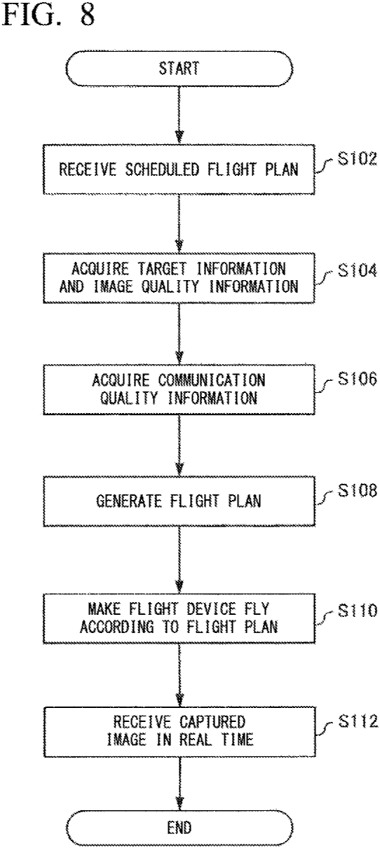

FIG. 8 is a flowchart showing an operation example of the flight management system 200.

The flowchart of FIG. 8 starts from when the flight plan generation device 210 of the flight management system 200 receives a scheduled flight plan input from the user terminal 100 (step S102). The scheduled flight plan includes information on an imaging target of the imaging unit 330 of the flight device 300 and information on image quality of a captured image. Further, the scheduled flight plan includes a scheduled flight path.

Next, the first acquisition unit 221 of the flight plan generation device 210 acquires target information for specifying an imaging target imaged by the imaging unit 330 and image quality information for specifying required image quality of the captured image from the received scheduled flight plan (step S104).

Next, the second acquisition unit 222 acquires communication quality information on wireless communication quality in a predetermined area including a scheduled flight path of the flight device 300 (step S106). For example, the second acquisition unit 222 acquires communication quality information, which is stored in the storage unit 215, based on wireless communication quality when the flight device 300 has flown in the past in a predetermined area.

Next, the flight plan generation unit 223 generates a flight plan including a flight path of the flight device 300 and an imaging parameter of the imaging unit 330 based on the target information and image quality information acquired in step S104 and the communication quality information acquired in step S106 (step S108). For example, the flight plan generation unit 223 generates a flight plan including the flight path passing through the in-service area described with reference to FIG. 6 and an imaging direction in which the imaging unit 330 faces an imaging target during flight.

Next, the flight control device 240 of the flight management system 200 transmits the generated flight plan to the flight device 300 and causes the flight device 300 to fly according to the flight plan (step S110). That is, the flight control device 240 causes the flight device 300 to fly along a flight path of a flight plan and operates the imaging unit 330 based on an imaging parameter to image an imaging target during flight.

The flight management system 200 receives in real time a captured image captured by the imaging unit 330 during flight of the flight device 300 (step S112). The flight management system 200 transmits the received captured image to the user terminal 100. Thereby, a user of the user terminal 100 can check in real time the captured image captured by the imaging unit 330.

### Effects of the Present Embodiments

The flight plan generation device 210 according to the present embodiment acquires target information for specifying an imaging target of the imaging unit 330 of the flight device 300, image quality information for specifying required image quality of a captured image, and communication quality information on wireless communication quality of a predetermined area including a flight airspace of the flight device 300. Then, the flight plan generation device 210 generates a flight plan including a flight path of the flight device 300 and an imaging parameter of the imaging unit 330 based on the acquired target information, image quality information, and communication quality information.

Thereby, a flight path of the flight device 300 can be set to a path with stable wireless communication quality, and the imaging unit 330 can image a captured image satisfying required image quality. As a result, the flight device 300 flying according to the generated flight plan can transmit the captured image of the imaging target with desired image quality captured by the imaging unit 330 to the flight management system 200 in real time.

The present invention will be able to contribute to Goal 9 “let’s lay a foundation for industry and technological innovation” of sustainable development goals (SDGs) led by the United Nations.

Although the present invention is described above by using embodiments, a technical scope of the present invention is not limited to the scope described in the above embodiments, and various modifications and changes can be made within the scope of the gist. For example, all or part of a device can be functionally or physically distributed and integrated in any unit. Further, new embodiments resulting from any combination of the plurality of embodiments are also included in the embodiments of the present invention. An effect of the new embodiment obtained by the combination has the effect of the original embodiment together.

While preferred embodiments of the invention have been described and illustrated above, it should be understood that these are pivot of the invention and are not to be considered as limiting. Additions, omissions, substitutions, and other modifications can be made without departing from the scope of the invention. Accordingly, the invention is not to be considered as being limited by the pertaining description and is only limited by the scope of the appended claims.

What is claimed is:

1. A flight plan generation device which generates a flight plan of a flight device that transmits a captured image captured by an imaging unit through wireless communication during flight, the flight plan generation device comprising:
a first acquisition unit configured to acquire target information for specifying an imaging target to be imaged by the imaging unit during flight of the flight device and image quality information for specifying required image quality of a captured image of the imaging target;
a second acquisition unit configured to acquire communication quality information on wireless communication quality in a predetermined area including at least a flight airspace of the flight device; and
a flight plan generation unit configured to generate a flight plan including a flight path of the flight device and an imaging parameter of the imaging unit based on the acquired target information, image quality information, and communication quality information.

2. The flight plan generation device according to claim 1, wherein the flight plan generation unit images the imaging target specified from the acquired target information and generates the flight plan including a recommended flight path that transmits the captured image satisfying the required image quality through wireless communication.

3. The flight plan generation device according to claim 2, wherein, when the recommended flight path does not exist, the flight plan generation unit notifies a user of non-existence of the recommended flight path.

4. The flight plan generation device according to claim 1, wherein the imaging parameter includes an imaging direction of the imaging unit during flight of the flight device and image quality information for specifying image quality of the captured image.

5. The flight plan generation device according to claim 4, wherein the image quality information includes at least one of resolution, a bit rate, and a frame rate of the captured image.

6. The flight plan generation device according to claim 1, wherein the imaging parameter includes at least one of an angle of view, brightness, and an image compression rate of the captured image.

7. The flight plan generation device according to claim 1, wherein the first acquisition unit acquires the target information including a flight path of the flight device and an imaging direction of the imaging unit input by a user.

8. The flight plan generation device according to claim 7, wherein the flight plan generation unit generates the flight plan including a flight path different from the flight path included in the target information.

9. The flight plan generation device according to claim 1, wherein the first acquisition unit acquires the image quality information selected by a user according to a model of the imaging unit from a plurality of pieces of information on the required image quality.

10. The flight plan generation device according to claim 1, wherein the flight plan generation unit presents the generated flight plan to a user and outputs the flight plan to a flight control unit that controls the flight of the flight device, on a condition that the presented flight plan is approved by the user.

11. The flight plan generation device according to claim 1, wherein the second acquisition unit acquires the communication quality information based on wireless communication quality when the flight device has flown in the past in the predetermined area, or wireless communication quality when another flight device has flown in the past in the predetermined area.

12. The flight plan generation device according to claim 1, wherein the second acquisition unit acquires the communication quality information indicating wireless communication quality estimated by a simulator.

13. The flight plan generation device according to claim 1, further comprising:
a storage unit configured to store imaging unit information on an imaging unit installed on a ground in the predetermined area,
wherein the flight plan generation unit generates the flight plan based on the imaging unit information stored in the storage unit.

14. The flight plan generation device according to claim 1, wherein
the first acquisition unit further acquires flight purpose information on a purpose of flight of the flight device, and
the flight plan generation unit controls the generation of the flight plan further based on the flight purpose information.

15. A flight plan generation method which generates a flight plan of a flight device that transmits a captured image captured by an imaging unit through wireless communication during flight, the flight plan generation method comprising:
acquiring target information for specifying an imaging target to be imaged by the imaging unit during flight of the flight device and image quality information for specifying required image quality of a captured image of the imaging target;
acquiring communication quality information on wireless communication quality in a predetermined area including at least a flight airspace of the flight device; and
generating a flight plan including a flight path of the flight device and an imaging parameter of the imaging unit based on the acquired target information, image quality information, and communication quality information.
